(19) United States
(12) Patent Application Publication
(10) Pub. No.: US 2001/0046849 A1
(43) Pub. Date: Nov. 29, 2001

(54) MMIC double-balanced mixer

(75) Inventors: Jean-Francois Villemazet, Cintegabelle (FR); Eric Rogeaux, Plaisance Du Touch (FR)

Correspondence Address: SUGHRUE, MION ZINN, MACPEAK & SEAS, PLLC, Suite 800, 2100 Pennsylvania Avenue, N.W., Washington, DC, 20037-3213, US

(73) Assignee: ALCATEL

(21) Appl. No.: 09/863,312

(22) Filed: May 24, 2001

(30) Foreign Application Priority Data
May 25, 2000 (FR) 00 06 692

(51) Int. Cl. H04B 1/26

(52) U.S. Cl. 455/326; 455/323

(57) ABSTRACT

A double-balanced mixer for high-frequency signals includes a quad of four cold transistors in an in-line configuration, to the center of which a signal RF to be processed is fed and to each end of which a signal RF/2 whose phase relative to the signal RF is 180° is applied, and 180° couplers at the quad input and output. The mixer is designed to be implemented in the MMIC technology and to operate in the L, S, C, X or Ku band.

### BACKGROUND OF THE INVENTION

1. Field of the invention

The invention relates to a double-balanced high-frequency signal mixer and in particular to a mixer that can be implemented in a compact form and is intended to be incorporated into a monolithic microwave integrated circuit (MMIC).

2. Description of the prior art

The document FR-A-2762942 describes a double-balanced mixer that can be implemented in a compact form and is intended to be incorporated into an integrated circuit. As outlined in the document, this kind of mixer converts the frequency of an input signal, such as a radio-frequency (RF) signal into an output signal at a lower frequency, referred to as the intermediate-frequency (IF) signal, using a local oscillator (LO) signal. In theory the frequency of the output signal corresponds to the difference between the frequency of the RF signal and the frequency of the local oscillator signal. In practice the spectrum of the output signal generated includes a plurality of frequencies defined by the expression:

n.F_{RF}±m.F_{LO}

where m and n are integers.

180° couplers are usually provided at the input and output ports of the mixer to eliminate unwanted frequencies obtained in addition to the intermediate frequency at the output of a mixer by combining them with opposite phase.

The mixer includes non-linear components in a particular arrangement, for example four diodes in a ring configuration usually referred to as a quad or star configuration. The double-balanced mixer described in the document FR-A-2762942 previously mentioned includes a ring quad of four cold transistors. The 180° couplers can take various forms, one of the commonest structures being a hybrid ring referred to as a “rat-race”. The ring consists of a microstripline having a circumference equal to 1.5 k with outputs along it at intervals of λ/4, i.e. one quarter of the wavelength of the signal processed.

This kind of structure is unacceptable if the mixer must be included in an MMIC, because the overall size of the device is then too large.

The mixer disclosed in the document FR-A-2762942 is designed to have a much smaller overall size than the prior art mixers referred to above. It comprises a quad of cold transistors connected directly to two couplers respectively operating at the radio frequency and the intermediate frequency. The couplers are based on a structure with three coupled microstriplines with a length of λ/16, instead of the standard length of λ/4. It is therefore possible to implement a compact mixer on an AsGa substrate which is one-fifth the previous overall size. However, this solution with a ring quad of cold transistors is not easy to transpose to the coplanar technology. It is therefore not possible at present to benefit from the advantages, in particular the cost reduction, of that technology. As is known in the art, the coplanar technology avoids processing the rear face of the monolithic integrated circuits obtained. It also enables “flip-chip” mounting of the integrated circuit chips, which make automatic wiring possible, which is beneficial in terms of the frequency rise of the resulting circuits.

The invention therefore proposes a double-balanced mixer designed to be implemented in the coplanar technology to obtain a smaller overall size than prior art implementations and a conversion gain instead of the losses usually encountered.

### SUMMARY OF THE INVENTION

The invention therefore provides a double-balanced mixer for high-frequency signals including a quad of four cold transistors in an in-line configuration, to the center of which a signal RF to be processed is fed and to each end of which a signal RF/2 whose phase relative to the signal RF is 180° is applied, and 180° couplers at the quad input and output.

In one embodiment of the invention the 180° couplers are connected to the quad by CPS stripline or CPW woveguide coplanar connections.

In one embodiment of the invention the quad comprises two groups of two transistors connected by their drains, the two transistors of different groups at the middle of the row are connected by their sources, a point common to the two sources receives the signal RF to be processed, the sources of the two transistors at the ends of the row each receive a signal RF/2 whose phase relative to the signal RF is 180°, and intermediate-frequency signals IF and IF obtained by processing are supplied at the connection between the drains of the two transistors of each group.

In one embodiment of the invention the radio-frequency coupler includes three drain-source 180° couplers forming a group comprising an input coupler and two output couplers adapted to supply a radio-frequency signal RF to the quad at a first output and two signals RF/2 whose identical phase relative to the signal RF is 180° at two separate other outputs which are interconnected, the signals are obtained by selectively summing signals obtained at the output of two output couplers of the group which each receive a respective one of the signals with a relative phase of 180° supplied by the input coupler, via the drain and the source of a transistor, from a radio-frequency signal supplied to the input coupler and fed to the gate of the transistor, the two output couplers are disposed so that the drain of a first coupler and the source of the second coupler are grounded, in each case via a resistor, and the source of the first coupler and the drain of the second coupler are each connected via a resistor to the same potential, which is of negative polarity for the first coupler and of positive polarity for the second coupler, the radio-frequency signal appearing at the source of the first of the output couplers is combined by a capacitive connection with the radio-frequency signal appearing at the drain of the second of the output couplers to constitute the signal RF, and the respective radio-frequency signals appearing at the drain of the first output coupler and at the source of the second output coupler are distributed to two outputs which each supply a signal RF/2 and which are interconnected for electrical balancing.

In one embodiment of the invention the quad and the couplers are MMIC or hybrid devices.

The invention, its features and its advantages are explained in the following description, which is given with reference to the accompanying drawings.

### BRIEF DESCRIPTION OF THE DRAWINGS

FIG. 1 is a diagram of a quad which is for use in a mixer and is made up of cold transistors arranged in a line and excited by an arrangement specific to the invention.

FIG. 2 is a diagram of a radio-frequency coupler which is for use in a mixer and is intended to be associated with a quad of the kind shown in FIG. 1.

FIG. 3 reproduces part of a mask for an MMIC mixer in accordance with the invention.

### DETAILED DESCRIPTION OF THE PREFERRED EMBODIMENT

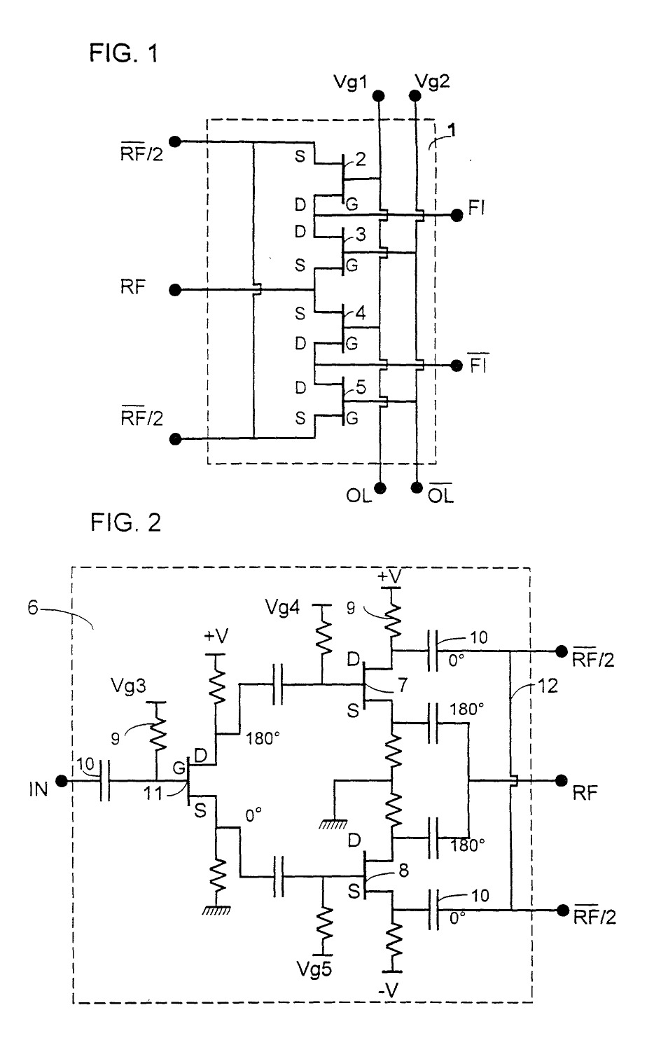

The quad 1 for use in a high-frequency signal mixer shown in FIG. 1 includes four transistors 2 to 5 disposed in an “in-line” configuration like stacked gate, drain and source fingers of a transistor, for example a cold PHEMT (Pseudomorphic High Electron Mobility Transistor). This kind of in-line quad produces a particularly compact configuration and enables interconnection by means of coplanar guides. The row formed by the transistors comprises two groups of two transistors, namely the group of transistors 2 and 3 and the group of transistors 4 and 5, in each of which the transistors are connected by their drain D. The transistors 3 and 4 in the middle of the row are connected by their source S. Bias voltages Vg1 and Vg2, which can be the same, are respectively applied to the gates G of the transistors 2 and 4 and to the gates of the transistors 3 and 5. The radio-frequency signal RF to be processed is injected into the quad 1 via three ports which respectively correspond to the point common to the interconnected sources S of the transistors 3 and 4 in the middle of the row and to the sources S of the transistors 2 and 5 which constitute the ends of the row formed by the quad 1. The port corresponding to the common point is intended to receive the signal RF, which is fed to it via a radio-frequency coupler, as defined later, and each of the two end ports is intended to receive a signal RF/2 whose phase relative to the RF signal from the radio-frequency coupler is 180°. In a preferred embodiment, a transmission line connects the sources of the transistors 2 and 5.

The local oscillator signal LO needed to process the radio-frequency signal RF is injected into the quad via two ports, each of which corresponds to one of the connections by which the gates of the transistors 2 to 5 are biased, as indicated above. In the embodiment shown in the diagram, the signal LO is applied to the gates of the transistors 2 and 4 and a signal LO whose phase relative to the signal LO is 180°is applied to the gates of the transistors 3 and 5.

The intermediate-frequency signal IF obtained by processing the radio-frequency signal in the quad 1 and its complement IF are respectively supplied by a port that corresponds to the point common to the drains of one of the groups, one of the groups consisting of the transistors 2 and 3 and the other group consisting of the transistors 4 and 5.

As indicated above, the quad 1 is connected by coplanar lines to three couplers which respectively inject the local oscillator signal and the radio-frequency signal to be processed and recover the intermediate-frequency signal at the ports defined above.

The disposition of the transistors of the quad 1 in a row does not provide directly the symmetry of a ring quad. The invention uses an RF coupler to excite simultaneously the ends of the row formed by the transistors of the quad 1 to prevent behavior at microwave operating frequencies from being degraded, as would occur if the ends of the quad were merely closed via a line.

The RF coupler 6 has three outputs, namely an output RF and two outputs RF/2, and is preferably a coupler exploiting the properties of drain-source active 180° couplers.

As is known in the art, a drain-source coupler usually has relatively poor performance in terms of amplitude and phase error between the outputs because of its asymmetry, as is clear on considering the drain and source ports of the equivalent electrical circuit diagram of its transistor.

To alleviate this drawback, the invention sums the outputs of the two drain-source couplers, as shown in FIG. 2, in which an RF coupler 6 includes two transistors 7 and 8 which are affiliated so that they can be operated in this way. To this end, the drain of the transistor 7 is connected to a particular positive voltage +V, for example 5 volts, and its source is grounded, and the drain of the transistor 8 is grounded and its source is connected to a negative potential equal to −V, in each case via a resistor 9. The source S of the transistor 7 and the drain D of the transistor 8 are coupled via capacitors 10 to constitute the RF output of the coupler 6. The drain D of the transistor 7 and the source S of the transistor 8 each produce a signal RF/2 at an output of the coupler 6 via a capacitor 10. To achieve the electrical balance needed to enable the coupler 6 to operate at high frequencies, the two signal outputs RF/2 are interconnected by a connection 12 on the opposite side of the capacitors 10 to the transistors 7 and 8. A natural balance is therefore achieved by using the same electrical circuit diagram for both ports from the coupler 6 to the quad 1, which reduces unwanted amplitude and phase errors between the signals transmitted via those ports.

Affiliating in-phase pairs of outputs of the two output couplers, based on the transistors 7 and 8, entails using an input coupler to excite the transistors 7, 8 with an appropriate relative phase. Here the input coupler is another drain-source 180° coupler based on a transistor 11.

The gate of the transistor 11 receives the radio-frequency signal to be processed via a port IN and is connected to a bias voltage Vg3. The drain of the transistor 1 1 is connected via a resistor 9 to the voltage +V and via a capacitor 1 0 to the gate of the transistor 7, which is connected to the bias voltage Vg4. The source of the transistor 11 is grounded via one of the resistors 9 and is connected via one of the capacitors 10 to the gate of the transistor 8, which gate is connected to the bias voltage Vg5.

In this embodiment, a balanced mixer in accordance with the invention incorporates an in-line quad, such as the quad 1 defined above, and a three-output radio-frequency coupler, like the coupler 6 also defined above. The quad and the coupler are affiliated with a two-input coupler for injecting a local oscillator frequency signal and a coupler with two output ports for the intermediate-frequency signal.

Using a coplanar technology for the whole of the mixer in accordance with the invention results in a very compact circuit, which can readily be integrated into an MMIC that can operate at high frequencies, for example in the Ku band. An additional feature of the resulting mixer is that it has a conversion gain of up to about +4 dB, instead of the losses encountered in a prior art mixer, which are typically of the order of −12 dB.

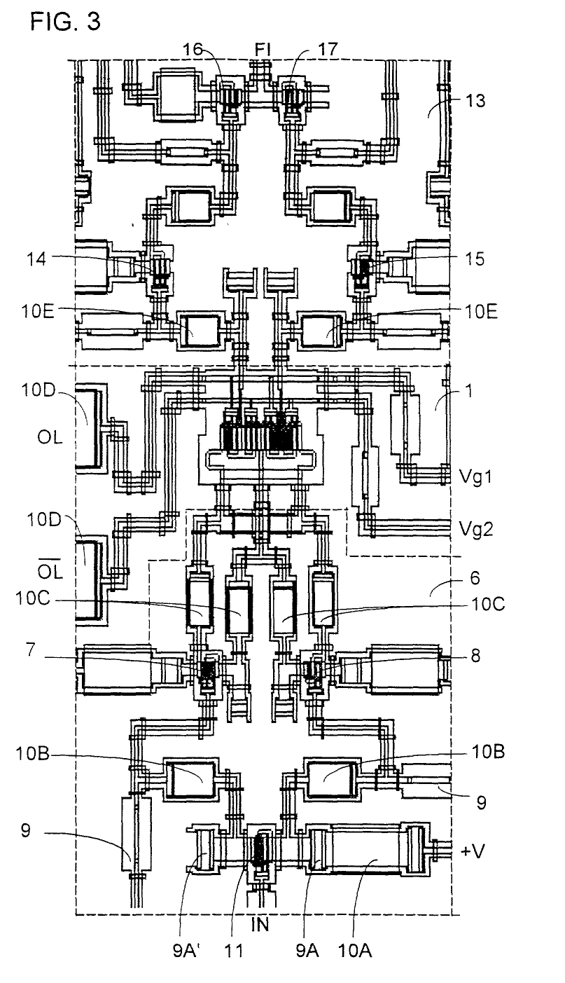

The portion of the mask relating to the mixer in accordance with the invention shown in FIG. 3 features three aligned subassemblies corresponding, from the bottom upwards, to the radio-frequency coupler 6, the quad 1 and the intermediate-frequency coupler. The radio-frequency signal received by the mixer is applied to a port IN of the radio-frequency coupler 6, in which the connections are of the coplanar waveguide (CPW) type. The radio-frequency signal is fed to the gate of the transistor 11 of the radio-frequency coupler 6. The drain of the transistor 1 1 is connected to the potential +V via a resistor 9A and a capacitor 10A. The source of the transistor 11 is grounded via the resistor 9A′. The source and the drain of the transistor 11 are each connected via a capacitor 10B to the respective gate of one of the transistors 7 and 8, which gates are respectively connected to the potentials Vg4 and Vg5 via resistors 9. The quad 1 includes CPS stripline type connections and is connected to the drain and to the source of each of the transistors 7 and 8 of the radio-frequency coupler 6 via capacitors 10C, which here are part of the coupler, through which the signal RF and the signals RF/2 are transmitted. As previously indicated, the quad 1 receives, via two capacitors 10D shown only in part, the local oscillator signals LO and LO which are fed to the gates of its four in-line transistors. The phase-shifted intermediate-frequency signals IF and IF produced by the quad are each fed to the gate of a respective input transistor 14 or 15 of a cascode circuit via a capacitor 10E. The circuit includes two output transistors 16 or 17 interconnected at their respective sources to supply the intermediate-frequency signal IF from the combination of the signals IF and IF applied to the gates of the input transistors 14 and 15. The gates of the transistors 16 and 17 are connected via capacitors to the drain of a respective input transistor 14 or 15 in a circuit arrangement that is known in the art.

There is claimed:

1. A double-balanced mixer for high-frequency signals including a quad of four cold transistors in an in-line configuration, to the center of which a signal RF to be processed is fed and to each end of which a signal RF/2 whose phase relative to the signal RF is 180° is applied, and 180° couplers at the quad input and output.

2. The mixer claimed in claim 1 wherein said quad comprises two groups of two transistors connected by their drains, said two transistors of different groups at the middle of said row are connected by their sources, a point common to said two sources receives said signal RF to be processed, the sources of said two transistors at the ends of said row each receive a signal RF/2 whose phase relative to said signal RF is 180°, and intermediate-frequency signals IF and IF obtained by processing are supplied at the connection between said drains of said two transistors of each group.

3. The mixer claimed in claim 1 wherein said radio-frequency coupler includes three drain-source 180° couplers forming a group comprising an input coupler and two output couplers adapted to supply a radio-frequency signal RF to said quad at a first output and two signals RF/2 whose identical phase relative to said signal RF is 180° at two separate other outputs which are interconnected, said signals are obtained by selectively summing signals obtained at the output of two output couplers of said group which each receive a respective one of said signals with a relative phase of 180° supplied by said input coupler, via the drain and the source of a transistor, from a radio-frequency signal supplied to said input coupler and fed to the gate of said transistor, said two output couplers are disposed so that the drain of a first coupler and the source of the second coupler are grounded, in each case via a resistor, and the source of the first coupler and the drain of the second coupler are each connected via a resistor to the same potential, which is of negative polarity for the first coupler and of positive polarity for the second coupler, the radio-frequency signal appearing at the source of the first of the output couplers is combined by a capacitive connection with the radio-frequency signal appearing at the drain of the second of said output couplers to constitute said signal RF, and the respective radio-frequency signals appearing at said drain of said first output coupler and at said source of said second output coupler are distributed to two outputs which each supply a signal RF/2 and which are interconnected for electrical balancing.

4. The mixer claimed in claim 1 wherein said 180° couplers for inserting and extracting said signals RF, RF/2, LO, LO, IF and IF are connected to said quad by CPS stripline or CPW waveguide coplanar connections.

5. The mixer claimed in claim 1 wherein said quad and said couplers are MMIC devices.

6. The mixer claimed in claim 1 wherein said quad and said couplers are hybrid devices.
